(19) United States
(12) Patent Application Publication
(10) Pub. No.: US 2023/0170132 A1
(43) Pub. Date: Jun. 1, 2023

(54) COIL COMPONENT

(71) Applicant: SAMSUNG ELECTRO-MECHANICS CO., LTD., Suwon-si (KR)

(72) Inventor: Min Oh LEE, Suwon-si (KR)

(73) Assignee: SAMSUNG ELECTRO-MECHANICS CO., LTD., Suwon-si (KR)

(21) Appl. No.: 17/885,932

(22) Filed: Aug. 11, 2022

(30) Foreign Application Priority Data
Dec. 1, 2021 (KR) 10-2021-0170008

(51) Int. Cl. H01F 27/28; H01F 27/24

(52) U.S. Cl. CPC H01F 27/2823; H01F 27/24

(57) ABSTRACT

A coil component includes a molded portion having one surface and the other surface opposing each other, and including a support portion and a core portion which is disposed on the support portion and includes a recess portion, and a wound coil disposed on the one surface of the molded portion, and having an innermost turn, at least one middle turn and an outermost turn, formed outward from a center of the one surface of the molded portion, wherein at least a portion of the innermost turn of the wound coil is disposed in the recess portion and, a maximum width of the recess portion is 30% or less of a width of the core portion, based on one cross-section of the coil component, including an axis of the core portion.

### CROSS-REFERENCE TO RELATED APPLICATION(S)

This application claims benefit of priority to Korean Patent Application No. 10-2021-0170008 filed on Dec. 1, 2021 in the Korean Intellectual Property Office, the disclosure of which is incorporated herein by reference in its entirety.

### TECHNICAL FIELD

The present disclosure relates to a coil component, and more particularly, to a coil component without a tilt phenomenon of a wound coil.

### BACKGROUND

There has been a continuous demand for a wire-wound power inductor implementing high efficiency characteristics in low-current and high-current environments. Accordingly, there is a trend to develop a power inductor implementing high efficiency in low-current and high-current environments by having reduced direct current resistance (Rdc) and increased inductance (Ls).

The wire-wound power inductor has a core, a central axis of a wound coil, wound in an alpha (∝) shape. When winding the coil, a first turn (a.k.a. cross turn) may be wound in the alpha (∝) shape, and a second turn to a final turn may then be wound. When viewing this coil in three-dimensions, it may be found that an intangible space is generated between the core, which is the central axis, and the second turn. Due to this space, a tilt phenomenon may occur in which the second turn is tilted toward the core that is the central axis. The reason is that when winding the coil, a predetermined amount of force (or tension) may be applied to a wire of the wound coil to control fusion (i.e. adhesion between the turns of the coil), an outer diameter and a wound shape, and this force may act from the outside of the wire toward the core. Accordingly, there is no tangible structure to support the second turn in the intangible space, this force may thus cause the wire to be tilted, and the coil may be wound by being tilted until the final turn.

When wound by being tilted, the wound coil may have a final outer diameter increased as compared to a design. The coil component may thus have a further reduced cut margin due to the increased outer diameter in a state where the cut margin is already insufficient, and furthermore, a defect may occur in which an internal coil is exposed due to the insufficient margin in a process of dicing the coil components.

### SUMMARY

An aspect of the present disclosure may provide a coil component having an improved dispersion while having a stable outer diameter of a coil.

Another aspect of the present disclosure may provide a coil component having no defective coil exposure by securing a cut margin.

Another aspect of the present disclosure may provide a coil component without a tilt phenomenon of a wound coil and thus having no damage to an insulating material disposed in a local region.

Another aspect of the present disclosure may provide a coil component having secured capacity and improved efficiency in a low current band, based on a secured cut margin.

According to an aspect of the present disclosure, a coil component may include: a molded portion having one surface and the other surface opposing each other, and including a support portion and a core portion which is disposed on the support portion and includes a recess portion; and a wound coil disposed on the one surface of the molded portion, and having an innermost turn, at least one middle turn and an outermost turn, formed outward from a center of the one surface of the molded portion, wherein at least a portion of the innermost turn of the wound coil is disposed in the recess portion, and a maximum width of the recess portion is 30% or less of a width of the core portion, based on one cross-section of the coil component, including an axis of the core portion.

According to another aspect of the present disclosure, a coil component may include: a molded portion having one surface and the other surface opposing each other, and including a core portion including a recess portion that has a helical shape extending from a surface of the core portion facing away from the one surface of the molded portion; and a wound coil disposed on the one surface of the molded portion, and having an innermost turn, at least one middle turn and an outermost turn, arranged outward from a center of the one surface of the molded portion, wherein at least a portion of the innermost turn of the wound coil is disposed in the recess portion.

### BRIEF DESCRIPTION OF DRAWINGS

The above and other aspects, features and advantages of the present disclosure will be more clearly understood from the following detailed description taken in conjunction with the accompanying drawings, in which:

FIG. 1 is a perspective view schematically illustrating a coil component according to an exemplary embodiment of the present disclosure;

FIG. 2 is an exploded perspective view of FIG. 1;

FIG. 3 is a cross-sectional view taken along line I-I′ of FIG. 1;

FIGS. 4A and 4B are perspective views each showing a core portion in detail;

FIGS. 5A and 5B are transmission cross-sectional views of the core portion, based on a direction A;

FIG. 6 is a cross-sectional view of a molded portion taken along line I-I′ of FIG. 1;

FIGS. 7A and 7B are perspective views each schematically illustrating a modified example of the core portion;

FIG. 8 is a cross-sectional view of a molded portion taken along line I-I′ of FIG. 7;

FIGS. 9A and 9B are perspective views each schematically illustrating another modified example of the core portion; and

FIGS. 10 through 12 each show a coil component according to another exemplary embodiment of the present disclosure.

### DETAILED DESCRIPTION

Hereinafter, exemplary embodiments in the present disclosure will now be described in detail with reference to the accompanying drawings.

In the drawings, an L direction refers to a first direction or a length direction, a W direction refers to a second direction or a width direction, and a T direction refers to a third direction or a thickness direction.

Hereinafter, a coil component according to exemplary embodiments of the present disclosure will be described in detail with reference to the accompanying drawings. In describing exemplary embodiments of the present disclosure with reference to the accompanying drawings, components that are the same as or correspond to each other will be denoted by the same reference numerals, and overlapping descriptions thereof will be omitted.

Various kinds of electronic components may be used in an electronic device, and various kinds of coil components may be appropriately used between these electronic components depending on their purposes in order to remove noise or the like.

That is, the coil component used in the electronic device may be a power inductor, high frequency (HF) inductor, a general bead, a bead for a high frequency (GHz), a common mode filter or the like.

### An Exemplary Embodiment

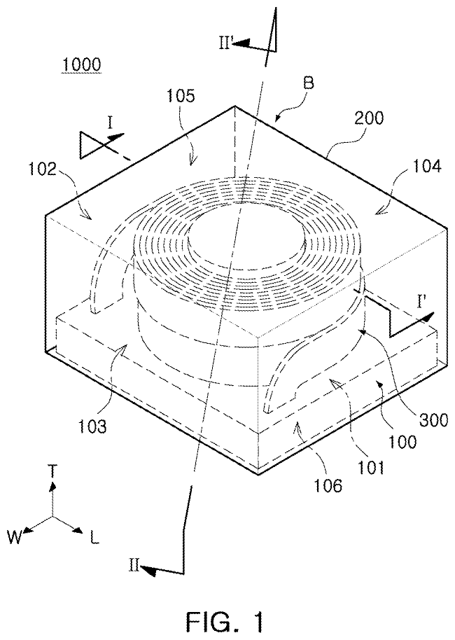

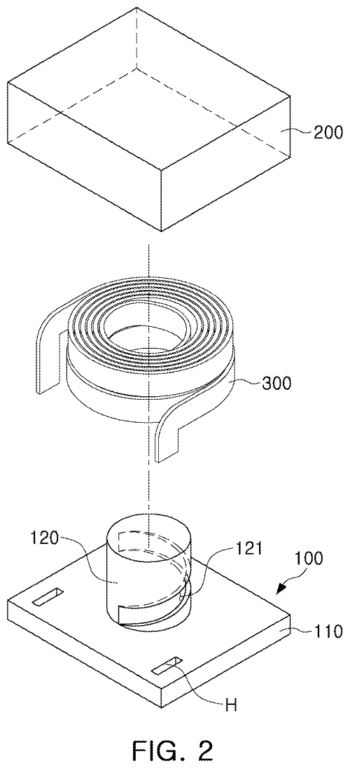

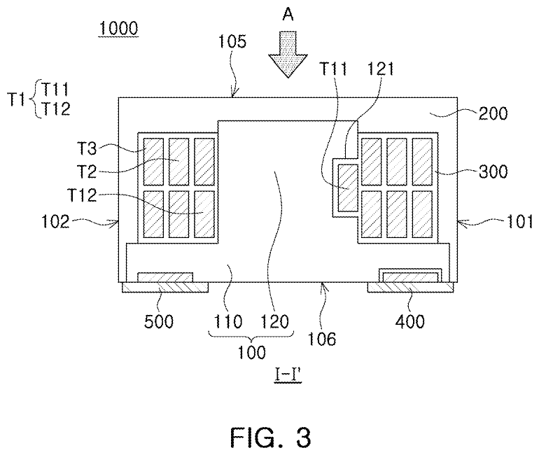

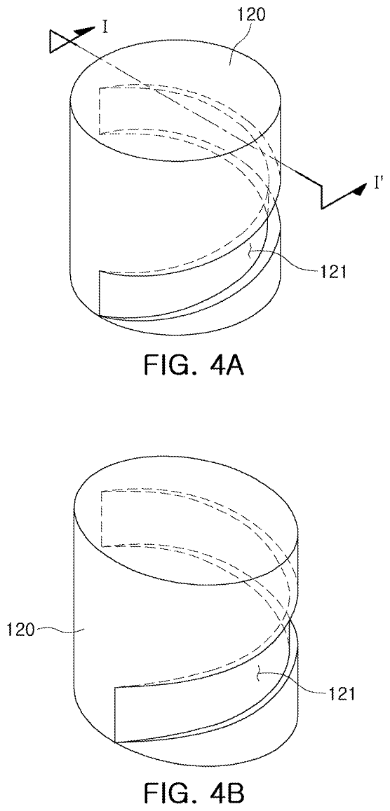

FIG. 1 is a perspective view schematically illustrating a coil component according to an exemplary embodiment of the present disclosure; FIG. 2 is an exploded perspective view of FIG. 1; and FIG. 3 is a cross-sectional view taken along line I-I′ of FIG. 1. Meanwhile, FIG. 2 illustrates only a molded portion 100, a wound coil 300 and a cover portion 200, which are main components for convenience of description. In addition, FIG. 4 omits a portion of a middle turn of the wound coil 300 illustrated in FIG. 1 for convenience.

In the present disclosure, the cross-section taken along line I-I′ and a cross-section taken along line II-II′ may all correspond to a cross-section passing through a central axis of a core portion 120.

Referring to FIGS. 1 through 3, a coil component 1000 according to an exemplary embodiment of the present disclosure may include a body B, the wound coil 300, and external electrodes 400 and 500. The body B may include the molded portion 100 and the cover portion 200. The molded portion 100 may include a support portion 110 and the core portion 120.

The body B may form an exterior of the coil component 1000 according to this exemplary embodiment, and may embed the wound coil 300 therein.

The body B may generally have a hexahedral shape.

The body B may have a first surface 101 and a second surface 102 opposing each other in the length (L) direction, a third surface 103 and a fourth surface 104 opposing each other in the width (W) direction, and a fifth surface 105 and a sixth surface 106 opposing each other in the thickness (T) direction, as illustrated in FIGS. 1 and 2. Each of the first to fourth surfaces 101, 102, 103 and 104 of the body B may correspond to a wall surface of the body B, connecting the fifth surface 105 and the sixth surface 106 of the body B to each other. Hereinafter, both end surfaces of the body B may refer to the first and second surfaces 101 and 102 of the body B, both side surfaces of the body B may refer to the third and fourth surfaces 103 and 104 of body B.

For example, the body B of the coil component 1000 including the external electrodes 400 and 500 described below according to this exemplary embodiment may have a length of 2.0 mm, a width of 1.2 mm and a thickness of 0.65 mm, and is not limited thereto.

Meanwhile, the body B may include the molded portion 100 and the cover portion 200. Here, the cover portion 200 may be disposed over the molded portion 100 with respect to FIG. 1 to surround all surfaces of the molded portion except for a lower surface thereof. Accordingly, the first to fifth surfaces 101, 102, 103, 104 and 105 of the body B may be formed by the cover portion 200, and the sixth surface 106 of the body B may be formed by the molded portion 100 and the cover portion 200.

The molded portion 100 may have one surface and the other surface opposing each other. The molded portion 100 may include the support portion 110 and the core portion 120. Here, the core portion 120 may include a recess portion 121 having a shape of a groove in which at least a portion of an innermost turn T1 described below is disposed. The support portion 110 may support the wound coil 300. The core portion 120 may be disposed in a center of one surface of the support portion 110 to pass through the wound coil 300. For the above reasons, in the present specification, one surface and the other surface of the molded portion 100 may respectively have the same meanings as one surface and the other surface of the support part 110.

The support portion 110 may have a thickness dm of 200 μm or more. When having the thickness dm of less than 200 μm, it may be difficult for the support portion 110 to secure its rigidity. The core portion 120 may have a thickness of 150 μm or more, and is not limited thereto.

The cover portion 200 may cover the molded portion 100 and the wound coil 300 described below. The cover portion 200 may be disposed over the support portion 110 and core portion 120 of the molded portion 100 and the wound coil 300, and then pressed to be coupled to the molded portion 100.

At least one of the molded portion 100 and the cover portion 200 may include the magnetic material. In this exemplary embodiment, both the molded portion 100 and the cover portion 200 may include the magnetic material. The molded portion 100 may be formed by filling a mold for forming the molded portion 100 with the magnetic material. Alternatively, the molded portion 100 may be formed by filling the mold with a composite material including the magnetic material and an insulating resin. It is possible to further perform a molding process of applying high temperature and high pressure to the magnetic material or composite material in the mold, and the present disclosure is not limited thereto. The support portion 110 and the core portion 120 may be formed integrally with each other using the mold. The cover portion 200 may be formed by disposing a magnetic composite sheet in which the magnetic materials are dispersed in the insulating resin on the molded portion 100 and then heating and pressing the same.

The magnetic material may be ferrite or metal magnetic powder particles.

The ferrite powder particles may include, for example, at least one of a spinel type ferrite such as Mg—Zn-based ferrite, Mn—Zn-based ferrite, Mn—Mg-based ferrite, Cu—Zn-based ferrite, Mg—Mn—Sr-based ferrite or Ni—Zn-based ferrite; a hexagonal type ferrite such as Ba—Zn-based ferrite, Ba—Mg-based ferrite, Ba—Ni-based ferrite, Ba—Co-based ferrite or Ba—Ni—Co-based ferrite; and a garnet type ferrite such as Y-based ferrite or Li-based ferrite.

The metal magnetic powder particles may include one or more selected from the group consisting of iron (Fe), silicon (Si), chromium (Cr), cobalt (Co), molybdenum (Mo), aluminum (Al), niobium (Nb), copper (Cu) and nickel (Ni). For example, the metal magnetic powder particles may be one or more of pure iron powder particles, Fe—Si-based alloy powder particles, Fe—Si—Al-based alloy powder particles, Fe—Ni-based alloy powder particles, Fe—Ni—Mo-based alloy powder particles, Fe—Ni—Mo—Cu-based alloy powder particles, Fe—Co-based alloy powder particles, Fe—Ni—Co-based alloy powder particles, Fe—Cr-based alloy powder particles, Fe—Cr—Si-based alloy powder particles, Fe—Si—Cu—Nb-based alloy powder particles, Fe—Ni—Cr-based alloy powder particles and Fe—Cr—Al-based alloy powder particles.

The metal magnetic powder particles may be amorphous or crystalline. For example, the metal magnetic powder particles may be Fe—Si—B—Cr based amorphous alloy powder particles, and are not necessarily limited thereto.

The ferrite and the metal magnetic powder particles may have average diameters of about 0.1 μm to 30 μm, respectively, and are not limited thereto.

The molded portion 100 and the cover portion 200 may each include two or more types of magnetic materials. Here, different types of magnetic materials may refer to the magnetic materials distinguished from each other by any one of an average diameter, a composition, crystallinity and a shape.

The insulating resin may include epoxy, polyimide, liquid crystal polymer (LCP) or the like, or a mixture thereof, and is not limited thereto.

The wound coil 300 may be embedded in the body B to express a characteristic of the coil component. For example, when the coil component 1000 of this exemplary embodiment is used as the power inductor, the wound coil 300 may serve to store an electric field as a magnetic field to maintain an output voltage, thereby stabilizing power of the electronic device.

The wound coil 300 may be disposed on one surface of the molded portion 100. In detail, the wound coil 300 may be wound around the core portion 120 and disposed on one surface of the support portion 110.

The wound coil 300 may be an air-core coil and may be a flat coil. The wound coil 300 may be formed by winding, in a spiral shape, a metal wire such as a copper wire whose surface is covered by an insulating material.

The wound coil 300 may have the multi-layers. Each layer of the wound coil 300 may have the planar spiral shape, and may have a plurality of turns. That is, the wound coil 300 may have the innermost turn T1, at least one middle turn T2 and an outermost turn T3, formed outward from the center of one surface of the molded portion 100. Here, the innermost turn T1 may include a first innermost turn T11 disposed inside the core portion 120 when viewed from the thickness (T) direction and a second innermost turn T12 disposed outside the core portion 120 when viewed from the thickness (T) direction. The first innermost turn T11 may refer to a region of the innermost turn T1, disposed in the recess portion 121 formed in the core portion 120.

When viewing the wound coil 300 wound in the body B, the above first innermost turn T11 may be a region in which one layer is connected to another layer among the multi-layers of the wound coil 300. Accordingly, the first innermost turn T11 may have a helical shape by being in contact with a side surface of the core portion 120 and wound in the same direction as a direction in which the winding coil 300 is wound. The coil component may generally have a cylindrical core portion. In this case, a phenomenon may occur in which the second innermost turn T12, at least one middle turn T2 and the outermost turn T3 are tilted inward due to the helical first innermost turn T11. In the coil component 1000 according to an exemplary embodiment of the present disclosure, the helical recess portion 121 may be formed in the core portion 120, and the first innermost turn T11 may be disposed in the recess portion 121, and it is thus possible to prevent the tilt phenomenon in which the other turns of the wound coil are tilted. It is thus possible to prevent an unnecessarily increase an outer diameter of the wound coil 300 and secure a cut margin outside the body.

The coil component 1000 according to this exemplary embodiment may secure the cut margin, thereby preventing a defect in which a portion of the coil 300 is exposed to the side surface of the body B to have an improved yield. In addition, it is possible to increase capacity of the body B by securing the cut margin, and it is thus possible to prevent a deteriorated characteristic of the component such as a lower inductance (Ls).

In addition, it is possible to prevent the tilt phenomenon of the wound coil 300, thereby preventing damage to the insulating material disposed in a local region, which is caused by friction between the tilted coil and a surface of the first innermost turn T1 that is not tilted.

TABLE 1

| | TILT ANGLE (°) OF | OUTER DIAMETER | INCREASED | ELECTRODE |
|---|---|---|---|---|
| No. | WOUND COIL | (MM) | RATE (%) | EXPOSURE |
| COMPARATIVE | 0 | 2.340 | 0 | OK |
| EXAMPLE | | | | |
| CASE 1 | 5 | 2.346 | 1.5 | OK |
| CASE 2 | 10 | 2.353 | 3.3 | OK |
| CASE 3 | 15 | 2.360 | 5 | OK |
| CASE 4 | 20 | 2.369 | 7.3 | NG |
| CASE 5 | 25 | 2.379 | 7.8 | NG |
| CASE 6 | 30 | 2.390 | 12.5 | NG |
| CASE 7 | 35 | 2.402 | 15.5 | NG |
| CASE 8 | 40 | 2.415 | 18.8 | NG |
| CASE 9 | 45 | 2.429 | 22.3 | NG |
| CASE 10 | 50 | 2.444 | 26 | NG |

Referring to Table 1, cases 1 to 3 show that a defective electrode exposure does not occur when the coil maintains a tilt angle of 15° or less, and cases 4 to 10 show that the defective electrode exposure occurs when the coil has the tilt angle of 20° or more.

As such, the core portion 120 having a shape according to the present disclosure may be introduced into the coil component 1000 embedding the wound coil 300 therein, thereby preventing the tilt phenomenon of the wound coil 300, and the increased outer diameter of the wound coil 300 to effectively prevent the defective electrode exposure.

Both ends of the wound coil 300 may be exposed to the other surface of the support portion 110, that is, the sixth surface 106 of the body B. Both the ends of the wound coil 300, exposed to the other surface of the support portion 110, may be connected to the first and second external electrodes 400 and 500, disposed on the other surface of the support portion 110 while being spaced apart from each other.

Both the ends of the wound coil 300 may be exposed to (or extend from) the other surface of the support portion 110. For example, as illustrated in FIG. 2, the support portion 110 may have a pair of receiving portions H having a through-hole shape and passing through the support portion 110, and both the ends of the wound coil 300 may respectively be disposed in the receiving portions H. Meanwhile, it is possible to arbitrarily change the shape and disposition of the through-hole-shaped receiving portion H. Unlike as illustrated in FIG. 2, the receiving portion H may have, for example, a circular or elliptical cross-sectional shape, and is not limited thereto.

For another example, as illustrated in FIG. 3, both the ends of the wound coil 300 may be disposed on the side surfaces of the support portion 110, and exposed to the other surface of the support portion 110. Here, the receiving portion H having a groove shape may be formed in the side surfaces of the support portion 110 to accommodate both the ends of the wound coil 300, and is not limited thereto.

The first and second external electrodes 400 and 500 may be disposed on the other surface of the support portion 110, that is, the sixth surface 106 of the body B, while being spaced apart from each other, and may respectively be connected to both the ends of the wound coil 300.

The first and second external electrodes 400 and 500 may each have a single-layer or multi-layer structure. For example, the external electrodes 400 may be disposed on a first layer including copper (Cu), a second layer disposed on the first layer and including nickel (Ni), and a third layer disposed on the second layer and including tin (Sn). The first or second external electrode 400 or 500 may be formed by electroplating, and is not limited thereto.

The first or second external electrode 400 or 500 may be formed of a conductive material such as copper (Cu), aluminum (Al), silver (Ag), tin (Sn), gold (Au), nickel (Ni), lead (Pb), chromium (Cr), titanium (Ti) or an alloy thereof, and is not limited thereto.

Meanwhile, although not illustrated in the drawings, the coil component 1000 according to this exemplary embodiment may further include an insulating layer disposed in a region of the sixth surface 6 of the body B, except for a region where the external electrode 400 or 500 is disposed. The insulating layer may be used as a plating resist when forming the external electrode 400 or 500 by the electroplating, and is not limited thereto. In addition, the insulating layer may also be disposed on at least a portion of the first to fifth surfaces 101, 102, 103, 104 and 105 of the body B.

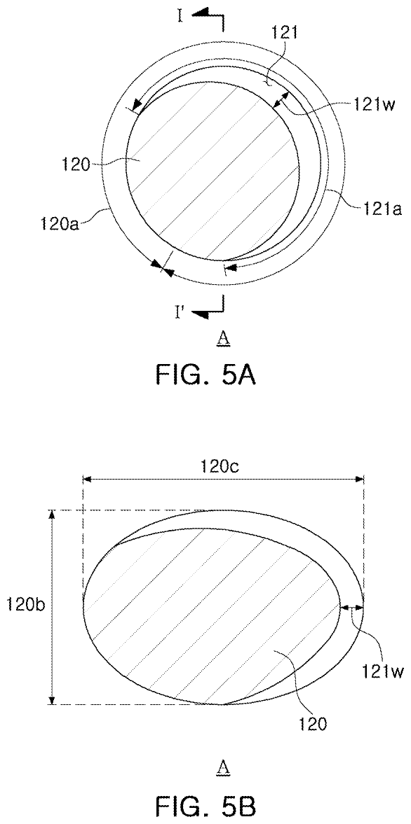

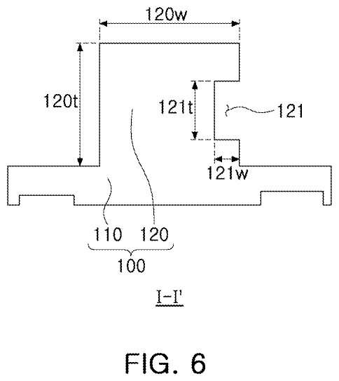

FIGS. 4A and 4B are perspective views each showing the core portion in detail; FIGS. 5A and 5B are transmission cross-sectional views of the core portion, based on a direction A; and FIG. 6 is a cross-sectional view of a molded portion taken along line I-I′ of FIG. 1.

FIG. 4 is the perspective view separately showing only the core portion 120 of the coil component 1000 according to an exemplary embodiment. The core portion 120 according to an exemplary embodiment may have a cylindrical column shape or an elliptical column shape, formed by extending a circular cross-section of the core portion from one end to the other end, and is not limited thereto. The core portion 120 may have a shape of any three-dimensional figure without limitation as long as the coil 300 may be wound around the core portion, such as a triangular column, a square column, a pentagonal column, a hexagonal column or the like. That is, the core portion 120 may have the cross-section having the circular or elliptical shape or the polygonal shape such as the triangular, square, pentagonal or hexagonal shape, based on a length-width (LW) cross-section.

For example, FIG. 4A illustrates the core portion 120 having the cylindrical column shape, and FIG. 4B illustrates the core portion 120 having the elliptical column shape, respectively. The following descriptions of the core portion 120 and the recess portion 121 formed in the core portion 120 may be applied regardless of a shape of the core portion 120. The drawings below illustrate the core portion 120 having the cylindrical column shape or the elliptical column shape for convenience.

The core portion 120 may have one cross-section (or lower surface) and the other cross-section (or upper surface) opposing the one cross-section, and may have a side surface connecting the one cross-section and the other cross-section. As shown in FIGS. 4A and 4B, the recess portion 121 recessed in the groove shape may be formed in the side surface of the core portion 120. For example, “upper” and “lower” may be defined as upward and downward in the T direction as shown in, for example, FIG. 1.

The recess portion 121 may be recessed in the side surface of the core portion 120 from the outside of the core portion 120 toward the inside of the core portion 120, and may have the helical shape. That is, one end and the other end of recess portion 121 may be disposed at different heights. For example, the core portion 120 of FIG. 4 illustrates that one end of the recess portion 121 may be in contact with one cross-section of the core portion 120, and the other end of the recess portion 121 may be formed at a height different from a height of the one cross-section of the core portion 120.

One end and the other end of the recess portion 121 may each have a polygonal cross-section. That is, the recess portion 121 may be formed as a line-shaped groove portion formed by extending the polygonal cross-section starting from one end to the other end, in which the line shape may be formed in a curved shape and simultaneously formed along the side surface of the core portion 120, which has the cylinder column shape or the elliptical column shape. As a result, the recess portion 121 may have the helical shape in which the recess portion shares its axis with the core portion 120.

FIG. 5 is a transmission cross-sectional view of the other cross-section of the core portion 120, based on the direction A. As shown in FIG. 5, the recess portion 121 may start from one end and be extended to pass by half (½) of a perimeter of the core portion 120 or more. That is, a length of the recess portion 121, overlapping a length of the side surface of the core portion 120, may be greater than a half-length (½) of the perimeter or diameter of the core portion, based on an axis direction (or direction A) of the core portion.

In the present disclosure, based on the axis direction of the core portion 120, the “perimeter” of the core portion 120 may refer to the length of a closed-loop formed by the cross-sectional shape of the core portion 120. For example, the “perimeter” may be a circumference of the circle when the LW cross-section of the core portion 120 has the circular shape, and may be a total length of four corners of the square when the LW cross-section of the core portion 120 has the square shape.

FIG. 5A exemplarily illustrates the cross-section of the core portion 120 having the cylindrical column shape, and FIG. 5B exemplarily illustrates the cross-section of the core portion 120 having the elliptical column shape, based on the axis direction of the core portion.

As illustrated in FIG. 5A, a length 121a of the recess portion 121 overlapping the length of the side surface of the core portion 120 may be greater than a half-length (½) of a diameter 120a of the cross-section of the circular core portion 120, based on the axis direction (or direction A) of the core portion 120. The reference number 121a may denote the length of the recess portion 121 overlapping the length of the side surface of the core portion 120 even though illustrated as being positioned in the recess portion 121 for convenience of description. Similarly, the reference number 120a may denote the perimeter, i.e. circumference of the cross-section of the core portion 120 based on the axis direction of the core portion 120 even though illustrated as being positioned outside the core portion 120 for convenience of description.

In addition, as illustrated in FIG. 5B, the core portion 120 may have the elliptical cross-section, and the ellipse may have a major axis 120c and a minor axis 120b. The length of the recess portion 121 overlapping the length of the side surface of the core portion 120 may be greater than the half-length (½) of the perimeter of the cross-section of the elliptical core portion 120, based on the axis direction (or direction A) of the core portion 120.

The recess portion 121 formed on the core portion 120 of the present disclosure may pass by half the perimeter of the core portion 120 or more, based on the axis direction (or direction A) of the core portion 120. The recess portion 121 may pass by half the perimeter of the core portion 120 or more, thus reducing a deviation in the outer diameters, i.e. difference in the outer diameters of the coils respectively positioned in different layers among the plurality layers of the wound coil 300.

In the present disclosure, the “outer diameter” may refer to a greatest distance of the coil in the corresponding direction. For example, the outer diameter of the coil disposed on a lower layer or layer 1 of the wound coil 300 in the width (W) direction may refer to a smallest distance between a cross-section of the body first coming into contact with the wound coil disposed on the lower layer and a cross-section of the body last coming into contact with the same coil when slicing the body in the width (W) direction to obtain its cross-sections perpendicular to the width (W) direction from one side surface to the other side surface.

In this exemplary embodiment, the recess portion 121 and the first innermost turn T11 may have the helical shape wound in the same shape, and the width and thickness of the first innermost turn T11 may respectively be the same as or smaller than the width 121w and thickness 121t of the recess portion 121. Therefore, the first innermost turn T11 of the wound coil 300 may be disposed stably in the recess portion 121, thus preventing the phenomenon in which the wound coil 300 including the other turns T12, T2 and T3 is tilted.

Meanwhile, as illustrated in FIGS. 4A through 5B, the recess portion 121 may include at least two regions having different widths 121w. For example, the recess portion 121 may have one end and the other end helically extended from the one end, and may have one end and the other end each having a minimum width. In addition, the recess portion 121 may have a middle portion connecting one end and the other end and having a maximum width.

A region of the recess portion 121, in which one end and the middle portion are connected to each other, may have an increased or reduced width. Similarly, a region of the recess portion 121, in which the other end and the middle portion are connected to each other, may have an increased or reduced width.

FIG. 6 is the cross-sectional view of the molded portion 100 taken along line I-I′. In the present disclosure, a cross-section of the molded portion 100 taken along line I-I′ may be its surface parallel to the third and fourth surfaces 103 and 104 and passing through the axis of the core portion 120.

The core portion 120 may have a width 120w and a thickness 120t, based on the cross-section taken along line I-I′. In addition, the recess portion 121 may have the width 121w and the thickness 121t. The width 120w of the core portion 120 and the width 121w of the recess portion 121 may each be a maximum length obtained based on one cross-section thereof measured in a direction (or a horizontal direction in FIG. 6) perpendicular to the axis direction of the core portion 120 (or a vertical direction in FIG. 6). In this case, the widths 120w and 121w may each be determined by averaging the lengths obtained based on a plurality of cross-sections thereof measured in the same direction. In addition, the thickness 120t of the core portion 120 and the thickness 121t of the recess portion 121 may each be a maximum length obtained based on the one cross-section thereof measured in the axis direction of the core portion 120. In this case, the thicknesses 120t and 121t may be determined by averaging the lengths obtained based on a plurality of cross-sections thereof measured in the same direction. As described above, the width and thickness of the wound coil 300 may respectively be the same as the width and thickness of the recess portion 121, or may respectively be smaller than the width and thickness of the recess portion 121. For example, when the wound coil 300 is a square coil, its cross-section may have a width smaller than the width 121w, and a thickness smaller than the thickness 121t. The dimensions disclosed herein may be obtained from optical micrograph or electron micrograph of the cross-sections. Other methods and/or tools appreciated by one of ordinary skill in the art, even if not described in the present disclosure, may also be used.

Meanwhile, when a maximum value of the width 121w of the recess portion 121 is increased by a predetermined rate or more based on the cross-section illustrated in FIG. 6, the core portion 120 is unable to secure a sufficient volume in a region where the recess portion 121 is formed, and the core portion 120 may thus be damaged.

TABLE 2

| | WIDTH OR DIAMETER (μm) | MAXIMUM WIDTH OF | | |
|---|---|---|---|---|
| ITEM | OF CORE PORTION | RECESSION PORTION 121 | RATE (%) | RESULT |
| COMPARATIVE | 300 | 0 | — | — |
| EXAMPLE 1 | | | | |
| INVENTIVE | 300 | 50 | 16.7 | NORMAL |
| EXAMPLE 1 | | | | |
| INVENTIVE | 300 | 100 | 33.3 | NORMAL |
| EXAMPLE 2 | | | | |
| COMPARATIVE | 300 | 150 | 50 | DAMAGED |
| EXAMPLE 2 | | | | |
| COMPARATIVE | 300 | 200 | 66.7 | DAMAGED |
| EXAMPLE 3 | | | | |

Table 2 above takes the cylindrical core portion 120 as an example, and illustrates a result of determining whether the core portion 120 is damaged with increase in a rate of the width 121w of the recess portion 121 in examples 1 and 2 and Comparative examples 1 to 3. In examples 1 and 2, an experiment is conducted by increasing the maximum width 121w of the recess portion 121 by 50 μm. Here, the rate is calculated by comparing a width of the core portion 120 based on the cross-section taken along line I-I′ and the maximum width 121w of the different widths of the recess portion 121 with each other. The width of the core portion 120 based on the cross-section taken along line I-I′ may be the diameter of the cross-section of the core portion 120 based on the axis direction of the core portion. Comparative examples 2 and 3 each show that the maximum width 121w of the recess portion 121 is 50% or 66.7% of the width of the core portion 120. In this case, the core portion 120 fails to secure a sufficient area based on in the corresponding LW cross-section, and thus has lower rigidity, which leads to a defect in which the core portion 120 is damaged. Examples 1 and 2 show that the maximum width 121w of the recess portion 121 is 33.3% or less of the width of the core portion 120, and here, the core portion 120 is not damaged and is able to maintain a normal state. That is, it is possible to safely secure the cut margin without damaging the core portion 120 when the maximum width 121w of the recess portion 121 is 33.3% or less or stably 30% or less of the width 120w (or diameter) of the core portion 120.

Meanwhile, when the core portion 121 has the elliptical shape in the axis direction, based on the LW cross-section, the maximum width 121w of the recess portion 121 may be calculated by comparing the major axis 120c and the minor axis 120b to each other and then based on a length of the minor axis 120b, which is a smaller distance among a length of the major axis and that of the minor axis. It is possible to safely secure the cut margin without damaging the core portion 120 even when the maximum width 121w of the recess portion 121 is 33.3% or less or stably 30% or less of the length of the minor axis 120b, which is the smaller distance among the length of the major axis and that of the minor axis.

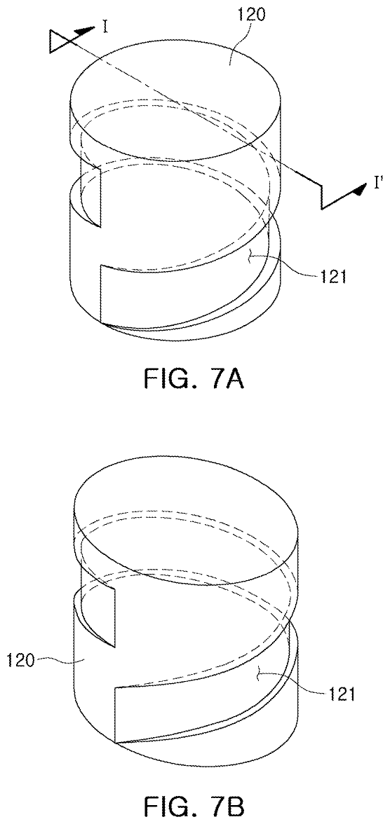

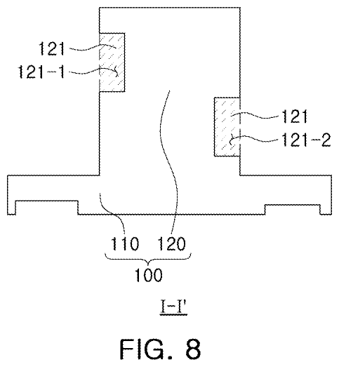

FIGS. 7A and 7B are perspective views each schematically illustrating a modified example of the core portion; and FIG. 8 is a cross-sectional view of a molded portion of FIG. 7 taken along line I-I′.

FIG. 7A exemplarily illustrates the cross-section of the core portion 120 having the cylindrical column shape, and FIG. 7B exemplarily illustrates the cross-section of the core portion 120 having the elliptical column shape, based on the axis direction of the core portion.

The core portions 120 according to the modified examples of FIGS. 7A and 7B may each have the circular cross-section and the elliptical cross-section, based on the axis direction (or direction A) of the core portion 120.

In this modified example, the recess portion 121 has the same length as the perimeter of the core portion 120, based on the axis direction (or direction A) of the core portion 120. That is, 360° may be an angle formed by both the ends of the recess portion 121 when its vertex is a center of the cross-section of the core portion 120, based on the axis direction (or direction A) of the core portion 120.

That is, the recess portion 121 may have one turn in the core portion 120 according to the modified example of FIG. 7A or 7B, based on the axis direction of the core portion 120. Here, an expression, “having one turn” may indicate that one end and the other end of the recess portion 121 overlap each other at the same position, based on the axis direction of the core portion 120. That is, it may be seen that one end and the other end of the recess portion 121 overlap each other at the same position even though the two ends actually have the different heights, based on the axis direction of the core portion 120.

As illustrated in the modified example of FIG. 7A or 7B, the recess portion 121 formed in the core portion 120 of the present disclosure may have the half-length of the perimeter of the core portion 120 or more, and furthermore, may have the same length as the perimeter of the core portion 120, thus reducing the deviation in the outer diameters, i.e. difference in the outer diameters of the coils respectively positioned in different layers among the plurality layers of the wound coil 300.

FIG. 8 is the cross-sectional view of the molded portion taken along line I-I′ of FIG. 7.

FIG. 8 is the cross-sectional view of the molded portion 100 taken along line I-I′ of FIG. 7. The cross-section of the core portion 120 may pass by the recess portion 121 twice based on the cross-section taken along line I-I′ in FIG. 7. That is, the cross-section taken along I-I′ of FIG. 7, which is one of cross-sections including the axis of the core portion 120, may overlap the recess portion 121 on the plurality of the cross-sections 121-1 and 121-2 spaced apart from each other. This structure may appear when the recess portion 121 has the half-length of the perimeter of the core portion 120 or more, based on the axis direction of the core portion 120, and may reduce the deviation in the outer diameters of the wound coil 300 having the multi-layer structure.

Tables 3 and 4 below show the outer diameters of the wound coils respectively disposed on the lower layer (or layer 1) and upper layer (or layer 2), in the length (L) direction and the width (W) direction, and the deviation in the outer diameters, based on the following examples.

TABLE 3

| | OUTER DIAMETER AND DEVIATION (mm) OF WOUND COIL IN L DIRECTION | | | | | |
|---|---|---|---|---|---|---|
| | RECESSION PORTION HAVING | | | RECESSION PORTION HAVING | | |
| | HALF-LENGTH (180°) OF | | | SAME LENGTH (360°) AS | | |
| | PERIMETER OF CORE PORTION | | | PERIMETER OF CORE POTRION | | |
| ITEM | Layer 1 | Layer 2 | DEVIATION | Layer 1 | Layer 2 | DEVIATION |
| INVENTIVE | 2.417 | 2.397 | 0.02 | 2.428 | 2.425 | 0.003 |
| EXAMPLE 3 | | | | | | |
| INVENTIVE | 2.416 | 2.398 | 0.018 | 2.429 | 2.425 | 0.004 |
| EXAMPLE 4 | | | | | | |
| INVENTIVE | 2.432 | 2.411 | 0.021 | 2.423 | 2.421 | 0.002 |
| EXAMPLE 5 | | | | | | |
| INVENTIVE | 2.448 | 2.408 | 0.04 | 2.423 | 2.42 | 0.003 |
| EXAMPLE 6 | | | | | | |
| INVENTIVE | 2.435 | 2.415 | 0.02 | 2.422 | 2.422 | 0 |
| EXAMPLE 7 | | | | | | |
| INVENTIVE | 2.434 | 2.416 | 0.018 | 2.426 | 2.42 | 0.006 |
| EXAMPLE 8 | | | | | | |
| INVENTIVE | 2.436 | 2.416 | 0.02 | 2.423 | 2.412 | 0.011 |
| EXAMPLE 9 | | | | | | |
| INVENTIVE | 2.42 | 2.398 | 0.022 | 2.426 | 2.424 | 0.002 |
| EXAMPLE 10 | | | | | | |
| INVENTIVE | 2.442 | 2.419 | 0.023 | 2.425 | 2.424 | 0.001 |
| EXAMPLE 11 | | | | | | |
| INVENTIVE | 2.43 | 2.413 | 0.017 | 2.424 | 2.418 | 0.006 |
| EXAMPLE 12 | | | | | | |
| INVENTIVE | 2.426 | 2.408 | 0.018 | 2.434 | 2.425 | 0.009 |
| EXAMPLE 13 | | | | | | |
| INVENTIVE | 2.427 | 2.397 | 0.03 | 2.426 | 2.421 | 0.005 |
| EXAMPLE 14 | | | | | | |
| INVENTIVE | 2.432 | 2.406 | 0.026 | 2.424 | 2.422 | 0.002 |
| EXAMPLE 15 | | | | | | |
| INVENTIVE | 2.434 | 2.412 | 0.022 | 2.424 | 2.419 | 0.005 |
| EXAMPLE 16 | | | | | | |
| INVENTIVE | 2.413 | 2.391 | 0.022 | 2.426 | 2.418 | 0.008 |
| EXAMPLE 17 | | | | | | |
| INVENTIVE | 2.427 | 2.411 | 0.016 | 2.425 | 2.424 | 0.001 |
| EXAMPLE 18 | | | | | | |
| INVENTIVE | 2.426 | 2.406 | 0.02 | 2.427 | 2.426 | 0.001 |
| EXAMPLE 19 | | | | | | |
| INVENTIVE | 2.424 | 2.408 | 0.016 | 2.424 | 2.418 | 0.006 |
| EXAMPLE 20 | | | | | | |
| INVENTIVE | 2.427 | 2.41 | 0.017 | 2.422 | 2.412 | 0.01 |
| EXAMPLE 21 | | | | | | |
| INVENTIVE | 2.418 | 2.402 | 0.016 | 2.425 | 2.422 | 0.003 |
| EXAMPLE 22 | | | | | | |
| INVENTIVE | 2.432 | 2.413 | 0.019 | 2.426 | 2.416 | 0.01 |
| EXAMPLE 23 | | | | | | |
| INVENTIVE | 2.412 | 2.395 | 0.017 | 2.429 | 2.428 | 0.001 |
| EXAMPLE 24 | | | | | | |
| INVENTIVE | 2.413 | 2.391 | 0.022 | 2.431 | 2.429 | 0.002 |
| EXAMPLE 25 | | | | | | |
| INVENTIVE | 2.429 | 2.412 | 0.017 | 2.428 | 2.419 | 0.009 |
| EXAMPLE 26 | | | | | | |
| INVENTIVE | 2.427 | 2.408 | 0.019 | 2.43 | 2.424 | 0.006 |
| EXAMPLE 27 | | | | | | |
| INVENTIVE | 2.431 | 2.4 | 0.031 | 2.423 | 2.41 | 0.013 |
| EXAMPLE 28 | | | | | | |
| INVENTIVE | 2.436 | 2.417 | 0.019 | 2.429 | 2.427 | 0.002 |
| EXAMPLE 29 | | | | | | |
| INVENTIVE | 2.428 | 2.411 | 0.017 | 2.427 | 2.422 | 0.005 |
| EXAMPLE 30 | | | | | | |
| INVENTIVE | 2.423 | 2.399 | 0.024 | 2.429 | 2.425 | 0.004 |
| EXAMPLE 31 | | | | | | |
| INVENTIVE | 2.431 | 2.414 | 0.017 | 2.421 | 2.418 | 0.003 |
| EXAMPLE 32 | | | | | | |
| INVENTIVE | 2.444 | 2.42 | 0.024 | 2.43 | 2.419 | 0.011 |
| EXAMPLE 33 | | | | | | |
| INVENTIVE | 2.426 | 2.409 | 0.017 | 2.429 | 2.421 | 0.008 |
| EXAMPLE 34 | | | | | | |
| Min | 2.412 | 2.391 | 0.016 | 2.421 | 2.410 | 0.000 |
| Max | 2.448 | 2.420 | 0.040 | 2.434 | 2.429 | 0.013 |
| Avg | 2.428 | 2.407 | 0.021 | 2.426 | 2.421 | 0.005 |
| StDev | 0.009 | 0.008 | 0.005 | 0.003 | 0.005 | 0.004 |

Table 3 above illustrates the deviation in the outer diameters of the upper wound coil and the lower wound coil in the length (L) direction when the recess portion 121 has the half-length (½) of the perimeter of the core portion 120 and when the recess portion 121 has the same length as the perimeter of core portion 120, based on examples 3 through 34.

That is, measured and compared are the outer diameters (or perimeters) of the recess portion 121 in the length (L) direction, based on the axis direction of the core portion 120 when the recess portion 121 is formed in a range of 180° (or has the half (½) length of the perimeter) with respect to the axis of the core portion 120 and when the recess portion 121 is formed in a range of 360° (or has the same length as the perimeter) with respect to the axis of core portion 120.

As illustrated in Table 3, it may be seen that a minimum deviation (Min) in the outer diameters is improved from 0.016 mm to 0.000 mm, a maximum deviation (Max) in the outer diameters is improved from 0.040 mm to 0.013 mm, and an average deviation (Avg) in the outer diameters is improved from 0.021 mm to 0.005 mm in the case where the recess portion 121 has the same length as the perimeter of the core portion 120 rather than in the case where the recess portion 121 has the half (½) length of the perimeter.

As illustrated above, it is possible to reduce the deviation in the outer diameters of the wound coils disposed on different layers, and the wound coil 300 disposed on one layer may not have more turns by that much. Accordingly, the entire wound coil 300 may not have the increased maximum outer diameter under an assumption of using the wound coil 300 having the same length. As a result, it is possible to further secure the cut margin on the side surface of the body B in the length (L) direction, thereby effectively preventing the defect in which the coil is exposed.

TABLE 4

| | OUTER DIAMETER AND DEVIATION (mm) OF WOUND COIL IN W DIRECTION | | | | | |
|---|---|---|---|---|---|---|
| | RECESSION PORTION 121 HAVING | | | RECESSION PORTION 121 HAVING | | |
| | HALF-LENGTH (180°) OF | | | SAME LENGTH (360°) AS | | |
| | PERIMETER OF CORE POTRION | | | PERIMETER OF CORE PORTION | | |
| ITEM | Layer 1 | Layer 2 | DEVIATION | Layer 1 | Layer 2 | DEVIATION |
| INVENTIVE | 1.819 | 1.799 | 0.02 | 1.815 | 1.812 | 0.003 |
| EXAMPLE 35 | | | | | | |
| INVENTIVE | 1.816 | 1.789 | 0.027 | 1.816 | 1.816 | 0 |
| EXAMPLE 36 | | | | | | |
| INVENTIVE | 1.81 | 1.789 | 0.021 | 1.82 | 1.819 | 0.001 |
| EXAMPLE 37 | | | | | | |
| INVENTIVE | 1.816 | 1.792 | 0.024 | 1.815 | 1.814 | 0.001 |
| EXAMPLE 38 | | | | | | |
| INVENTIVE | 1.817 | 1.796 | 0.021 | 1.822 | 1.815 | 0.007 |
| EXAMPLE 39 | | | | | | |
| INVENTIVE | 1.82 | 1.794 | 0.026 | 1.811 | 1.802 | 0.009 |
| EXAMPLE 40 | | | | | | |
| INVENTIVE | 1.821 | 1.804 | 0.017 | 1.817 | 1.813 | 0.004 |
| EXAMPLE 41 | | | | | | |
| INVENTIVE | 1.812 | 1.796 | 0.016 | 1.813 | 1.812 | 0.001 |
| EXAMPLE 42 | | | | | | |
| INVENTIVE | 1.819 | 1.802 | 0.017 | 1.818 | 1.818 | 0 |
| EXAMPLE 43 | | | | | | |
| INVENTIVE | 1.818 | 1.804 | 0.014 | 1.817 | 1.815 | 0.002 |
| EXAMPLE 44 | | | | | | |
| INVENTIVE | 1.806 | 1.792 | 0.014 | 1.814 | 1.814 | 0 |
| EXAMPLE 45 | | | | | | |
| INVENTIVE | 1.82 | 1.797 | 0.023 | 1.812 | 1.81 | 0.002 |
| EXAMPLE 46 | | | | | | |
| INVENTIVE | 1.81 | 1.796 | 0.014 | 1.82 | 1.815 | 0.005 |
| EXAMPLE 47 | | | | | | |
| INVENTIVE | 1.819 | 1.8 | 0.019 | 1.82 | 1.811 | 0.009 |
| EXAMPLE 48 | | | | | | |
| INVENTIVE | 1.811 | 1.798 | 0.013 | 1.816 | 1.812 | 0.004 |
| EXAMPLE 49 | | | | | | |
| INVENTIVE | 1.816 | 1.802 | 0.014 | 1.819 | 1.817 | 0.002 |
| EXAMPLE 50 | | | | | | |
| INVENTIVE | 1.819 | 1.797 | 0.022 | 1.819 | 1.813 | 0.006 |
| EXAMPLE 51 | | | | | | |
| INVENTIVE | 1.817 | 1.796 | 0.021 | 1.816 | 1.815 | 0.001 |
| EXAMPLE 52 | | | | | | |
| INVENTIVE | 1.825 | 1.802 | 0.023 | 1.816 | 1.813 | 0.003 |
| EXAMPLE 53 | | | | | | |
| INVENTIVE | 1.813 | 1.795 | 0.018 | 1.815 | 1.812 | 0.003 |
| EXAMPLE 54 | | | | | | |
| INVENTIVE | 1.807 | 1.793 | 0.014 | 1.819 | 1.815 | 0.004 |
| EXAMPLE 55 | | | | | | |
| INVENTIVE | 1.811 | 1.797 | 0.014 | 1.82 | 1.814 | 0.006 |
| EXAMPLE 56 | | | | | | |
| INVENTIVE | 1.822 | 1.802 | 0.02 | 1.81 | 1.809 | 0.001 |
| EXAMPLE 57 | | | | | | |
| INVENTIVE | 1.818 | 1.794 | 0.024 | 1.813 | 1.811 | 0.002 |
| EXAMPLE 58 | | | | | | |
| INVENTIVE | 1.817 | 1.79 | 0.027 | 1.815 | 1.812 | 0.003 |
| EXAMPLE 59 | | | | | | |
| INVENTIVE | 1.811 | 1.798 | 0.013 | 1.812 | 1.811 | 0.001 |
| EXAMPLE 60 | | | | | | |
| INVENTIVE | 1.828 | 1.792 | 0.036 | 1.816 | 1.814 | 0.002 |
| EXAMPLE 61 | | | | | | |
| INVENTIVE | 1.82 | 1.801 | 0.019 | 1.815 | 1.815 | 0 |
| EXAMPLE 62 | | | | | | |
| INVENTIVE | 1.816 | 1.802 | 0.014 | 1.818 | 1.817 | 0.001 |
| EXAMPLE 63 | | | | | | |
| INVENTIVE | 1.817 | 1.799 | 0.018 | 1.82 | 1.814 | 0.006 |
| EXAMPLE 64 | | | | | | |
| INVENTIVE | 1.806 | 1.794 | 0.012 | 1.815 | 1.811 | 0.004 |
| EXAMPLE 65 | | | | | | |
| INVENTIVE | 1.82 | 1.798 | 0.022 | 1.819 | 1.814 | 0.005 |
| EXAMPLE 66 | | | | | | |
| Min | 1.806 | 1.789 | 0.012 | 1.810 | 1.802 | 0.000 |
| Max | 1.828 | 1.804 | 0.036 | 1.822 | 1.819 | 0.009 |
| Avg | 1.816 | 1.797 | 0.019 | 1.816 | 1.813 | 0.003 |
| StDev | 0.005 | 0.004 | 0.005 | 0.003 | 0.003 | 0.003 |

Table 4 above illustrates the deviation in the outer diameters of the upper wound coil and the lower wound coil in the width (W) direction when the recess portion 121 has the half-length (½) of the perimeter of the core portion 120 and when the recess portion 121 has the same length as the perimeter of core portion 120, based on examples 35 through 66.

That is, measured and compared are the outer diameters (or perimeters) of the recess portion 121 in the width (W) direction, based on the axis direction of the core portion 120 when the recess portion 121 is formed in a range of 180° (or has the half (½) length of the perimeter) with respect to the axis of the core portion 120 and when the recess portion 121 is formed in a range of 360° (or has the same length as the perimeter) with respect to the axis of core portion 120.

As illustrated in Table 4, it may be seen that a minimum deviation (Min) in the outer diameters is improved from 0.012 mm to 0.000 mm, a maximum deviation (Max) in the outer diameters is improved from 0.036 mm to 0.009 mm, and an average deviation (Avg) in the outer diameters is improved from 0.019 mm to 0.003 mm in the case where the recess portion 121 has the same length as the perimeter of the core portion 120 rather than in the case where the recess portion 121 has the half (½) length of the perimeter of the core portion 120.

As illustrated above, it is possible to reduce the deviation in the outer diameters of the wound coils disposed on different layers, and the wound coil 300 disposed on one layer may not have more turns by that much. Accordingly, the entire wound coil 300 may not have the increased maximum outer diameter under the assumption of using the wound coil 300 having the same length. As a result, it is possible to further secure the cut margin on the side surface of the body B in the width (W) direction, thereby effectively preventing the defect in which the coil is exposed.

Meanwhile, although not illustrated, the recess portion 121 may be extended further than the perimeter of the core portion 120, based on the axis direction (or direction A) of the core portion 120, as illustrated in FIG. 8. That is, the recess portion 121 may have the plurality of turns formed in the side surface of the core portion 120. Unlike the turn of the wound coil 300, in the case of the turn of the recess portion 121, the recess portions formed in the same turn may respectively be disposed at different heights, and thus may have a helical shape as a result.

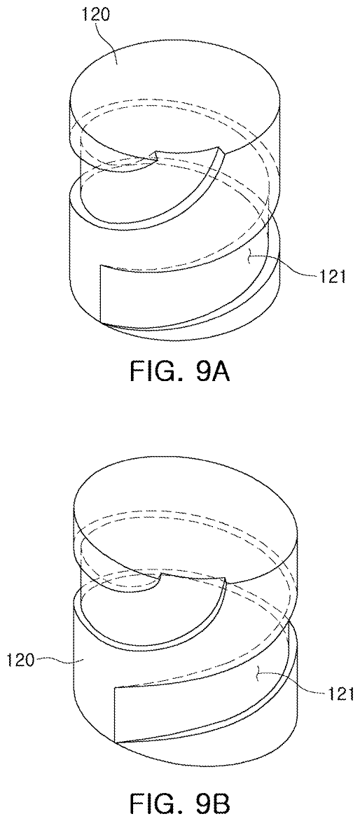

FIGS. 9A and 9B are perspective views each schematically illustrating another modified example of the core portion.

As illustrated in FIGS. 9A and 9B, one end of the recess portion 121 may be in contact with one cross-section (or lower surface) of the core portion 120, and the other end of the recess portion 121 may be directed to the other cross-section (or upper surface) of the core portion 120 to be externally exposed (or extend from the upper surface of the core portion 120). That is, when using the molded portion 100 including the core portion 120 according to another modified example, the recess portion 121 may be connected to the other cross-section of the core portion 120. In this manner, it is thus also possible to manufacture the wound coil 300 prevented from being tilted by using a method of separating the wound coil 300 prevented from being tilted from the core portion 120. In some embodiments, the upper surface of the core portion 120 may face away from the one surface of the molded portion 100. For example, the recess portion 121 may have a helical shape extending from the surface of the core portion 120 facing away from the one surface of the molded portion 100.

In the descriptions of FIGS. 8 through 9B, the description of the coil component 1000 according to an exemplary embodiment may be equally applied to the components other than the core portion 120. That is, a target of the present disclosure may be the coil component 1000 using the core portion 120 of various types according to an example and a modified example.

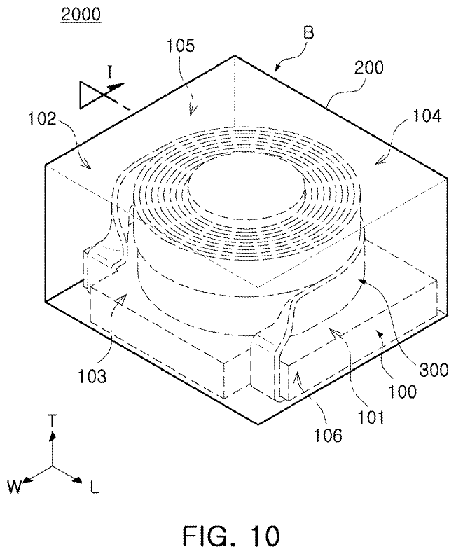

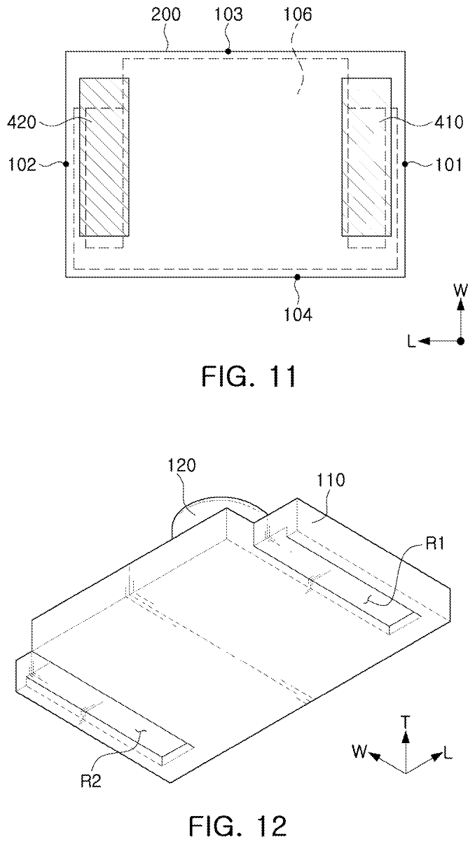

Another exemplary embodiment of the present disclosure is described with reference to FIGS. 10 through 12. The coil component 2000 according to this exemplary embodiment is different from an exemplary embodiment described above in a shape of the end of the wound coil 300 and a shape of the support portion 110, and therefore, the description only describes these differences. Groove portions R1 and R2 in which lead-out portions extended from both ends of the wound coil 300 are respectively disposed may be formed in the other surface of the support portion 110, and in one side surface of the support portion 110, on which the one surface and the other surface of the support portion 110 are connected to each other. Each of the two ends of the wound coil 300 may be disposed at a corner of the support portion 110 and may be bent to the lower surface of the support portion 100. To this end, the support portion 110 may have the corner partially removed to accommodate each of the two ends of the wound coil 300. The groove portions R1 and R2 of the support portion 110 may have a shape corresponding to that of the end of the wound coil 300. In addition, external electrodes 410 and 420 may be disposed on the sixth surface 106 of the body 100 while being spaced apart from each other.

As set forth above, the present disclosure may provide the coil component having the improved dispersion while having the stable outer diameter of the coil.

The present disclosure may also provide the coil component having no defective coil exposure by securing the cut margin.

The present disclosure may also provide the coil component without the tilt phenomenon of the wound coil and thus having no damage to the insulating material disposed in the local region.

The present disclosure may provide the coil component having the secured capacity and the improved efficiency in the low current band, based on the secured cut margin.

While exemplary embodiments have been illustrated and described above, it will be apparent to those skilled in the art that modifications and variations could be made without departing from the scope of the present disclosure as defined by the appended claims.

What is claimed is:

1. A coil component comprising:
a molded portion having one surface and the other surface opposing each other, and including a support portion and a core portion which is disposed on the support portion and includes a recess portion; and
a wound coil disposed on the one surface of the molded portion, and having an innermost turn, at least one middle turn and an outermost turn, arranged outward from a center of the one surface of the molded portion,
wherein at least a portion of the innermost turn of the wound coil is disposed in the recess portion and,
a maximum width of the recess portion is 30% or less of a width of the core portion, based on one cross-section of the coil component, including an axis of the core portion.

2. The coil component of claim 1, wherein the recess portion is disposed in a side surface of the core portion and has a helical shape.

3. The coil component of claim 2, wherein the recess portion extends from an upper surface of the core portion.

4. The coil component of claim 2, wherein any one of the cross-section including the axis of the core portion overlaps the recess portion in a plurality of regions of the recess portion, spaced apart from each other.

5. The coil component of claim 2, wherein the recess portion has the helical shape extended from its one end to the other end, and includes at least two regions having widths different from each other.

6. The coil component of claim 5, wherein the recess portion has the one end and the other end each having a minimum width.

7. The coil component of claim 2, wherein a length of the recess portion, overlapping a length of the side surface of the core portion, is greater than a half-length (½) of a perimeter of the core portion, based on an axis direction of the core portion.

8. The coil component of claim 2, wherein the recess portion has at least one turn disposed in the side surface of the core portion, based on the axis direction of the core portion.

9. The coil component of claim 1, wherein the width and thickness of the innermost turn disposed in the recess portion are the same as or smaller than the width and thickness of the recess portion.

10. The coil component of claim 1, further comprising:
a cover portion disposed over the one surface of the molded portion to cover the wound coil; and
first and second external electrodes disposed on the other surface of the molded portion while being spaced apart from each other, and respectively connected to the wound coil.

11. The coil component of claim 10, wherein both ends of the wound coil penetrate through the molded portion to respectively be connected to the first and second external electrodes, and extend from the other surface of the molded portion.

12. The coil component of claim 11, wherein at least one of the molded portion and the cover portion includes an insulating resin and magnetic powder particles dispersed in the insulating resin.

13. A coil component comprising:
a molded portion including a support portion and a core portion which is disposed on the support portion and includes a recess portion; and
a wound coil disposed on one surface of the molded portion, and having an innermost turn, at least one middle turn and an outermost turn, arranged outward from a center of the one surface of the molded portion,
wherein a length of the recess portion, overlapping a length of a side surface of the core portion, is greater than a half-length (½) of a perimeter of the core portion, based on an axis direction of the core portion.

14. The coil component of claim 13, wherein a width of the recess portion is 30% or less of a width of the core portion, based on one cross-section of the coil component, including an axis of the core portion.

15. A coil component comprising:
a molded portion having one surface and the other surface opposing each other, and including a core portion including a recess portion that has a helical shape extending from a surface of the core portion facing away from the one surface of the molded portion; and
a wound coil disposed on the one surface of the molded portion, and having an innermost turn, at least one middle turn and an outermost turn, arranged outward from a center of the one surface of the molded portion, wherein at least a portion of the innermost turn of the wound coil is disposed in the recess portion.

16. The coil component of claim 15, wherein a maximum width of the recess portion is 30% or less of a width of the core portion, based on one cross-section of the coil component, including an axis of the core portion.

17. The coil component of claim 16, wherein the maximum width is 16.7% or less of the width of the core portion.

18. The coil component of claim 15, wherein the molded portion further includes a support portion and the core portion is disposed on the support portion.
